(19) United States
(12) Patent Application Publication
(10) Pub. No.: US 2006/0245388 A1
(43) Pub. Date: Nov. 2, 2006

(54) Digital multimedia broadcasting receiver having public antenna connection module

(75) Inventor: Hyu-Myung Jeon, Seongnam-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd., Suwon-si (KR)

(21) Appl. No.: 11/412,855

(22) Filed: Apr. 27, 2006

(30) Foreign Application Priority Data
Apr. 27, 2005 (KR) 2005-35068

(51) Int. Cl. H04B 7/185

(52) U.S. Cl. 370/316

(57) ABSTRACT

A digital multimedia broadcasting receiver having a public antenna connection module. The digital multimedia broadcasting receiver for receiving satellite and terrestrial digital multimedia broadcasting, includes an antenna connection module which is connected with a satellite digital multimedia broadcasting antenna, including a jack used for connecting an external digital multimedia broadcasting receiving antenna. The antenna connection module cuts off a signal receiving path of the satellite digital multimedia broadcasting antenna and receives a digital multimedia broadcasting signal from the external digital multimedia broadcasting receiving antenna if the external digital multimedia broadcasting receiving antenna is connected to the jack. A switching module inputs a broadcasting signal received through the antenna connection module to a satellite digital multimedia broadcasting module if the broadcasting signal is a satellite digital multimedia broadcasting signal and inputs the broadcasting signal to a terrestrial digital multimedia broadcasting module if the broadcasting signal is a terrestrial digital multimedia broadcasting signal.

### PRIORITY

This application claims priority under 35 U.S.C. § 119 to an application entitled “Digital Multimedia Broadcasting Receiver Having Public Antenna Connection Module” filed in the Korean Intellectual Property Office on Apr. 27, 2005 and assigned Serial No. 2005-35068, the contents of which are incorporated herein by reference.

### BACKGROUND OF THE INVENTION

1. Field of the Invention

The present invention relates to digital multimedia broadcasting, and more particularly to a digital multimedia broadcasting receiver capable of connecting a variety of external multimedia broadcasting receiving antennas.

2. Description of the Related Art

Digital multimedia broadcasting is classified into satellite digital multimedia broadcasting and terrestrial digital multimedia broadcasting. Hereinafter, the structure of satellite and terrestrial digital multimedia broadcasting receivers will be described in detail based on block diagrams shown in FIGS. 1 and 2.

The terrestrial digital multimedia broadcasting receiver shown in FIG. 1 is connected with an external antenna through an antenna connection module 10 or has an internal antenna embedded therein. A digital multimedia broadcasting signal received through the external antenna or the internal antenna is input to a terrestrial digital multimedia broadcasting module 30 through an RF receiving module 20. The antenna connection module 10 is used for connecting an RF test cable.

The satellite digital multimedia broadcasting of FIG. 2 is subject to a fading phenomenon in which the amplitude of a digital multimedia broadcasting signal changes due to a multi-path phenomenon derived from a reflection wave caused by a building or a geographical feature on a wave path. In order to prevent the degradation of transmission quality caused by such fading phenomenon, a diversity antenna is used. In order to prevent the degradation of transmission quality, the portable terminal shown in FIG. 2 includes two antennas, a diversity antenna 100 for receving only a digital multimedia broadcasting signal and a wide band antenna 110 for receiving a digital multimedia broadcasting signal and a portable phone signal.

The diversity antenna 100 is connected with an antenna connection module 101, which includes a jack used for connecting an external antenna in addition to the diversity antenna 100. If the antenna connection modude 101 is connected to the external antenna through the jack, the antenna connection module 101 cuts off a signal receiving path from the diversity antenna 100 and inputs a digital multimedia broadcasting signal received through the connected external antenna to a satellite digital multimedia broadcasting module 103 through a Radio Frequency (RF) receiving module A 102. In addition, if the external antenna is not connected to the antenna connection module 101, the antenna connection module 101 inputs a digital multimedia broadcasting signal, which is received through the diversity antenna 100, to the satellite digital multimedia broadcasting module 103 through the RF receiving module A 102. The antenna connection module 101 may be similarly connected to an RF test cable.

The wide band antenna 110 is connected to an RF switching module 111. If the wide band antenna 110 receives a digital multimedia broadcasting signal or a portable phone signal, the wide band antenna 110 outputs the received signals to a diplexer 112 through the RF switching module 111. The diplexer 112 determines a type of the received signal according to the frequency of the received signal. If the received signal is determined to be a digital multimedia broadcasting signal, the signal is input to the satellite digital multimedia broadcasting module 103 throught the RF receiving module B 113. If the received signal is determined to be a portable terminal signal, the diplexer 112 inputs the received signal to a portable phone RF receiving module.

As shown in FIGS. 1 and 2, the terrestrial and satellite digital multimedia broadcasting receivers each must have one external antenna and one antenna connection module. Accordingly, when the structure of such terrestrial and sattellite digital multimedia broadcasting receivers is applied to the public portable terminal, two antenna connection modules are required. Accordingly, there is a spatial limitation when developing or redesigning portable terminals.

### SUMMARY OF THE INVENTION

Accordingly, the present invention has been made to solve the above-mentioned problems occurring in the prior art, and an object of the present invention is to provide a digital multimedia receiver capable of connecting to external satellite and terrestrial antennas through one antenna connection module.

To accomplish the above objects, there is provided a digital multimedia broadcasting receiver for receiving satellite digital multimedia broadcasting and terrestrial digital multimedia broadcasting, the digital multimedia broadcasting receiver including an antenna connection module which is connected with a satellite digital multimedia broadcasting antenna, includes a jack used for connecting an external digital multimedia broadcasting receiving antenna, and cuts off a signal receiving path of the satellite digital multimedia broadcasting antenna and receives a digital multimedia broadcasting signal from the external digital multimedia broadcasting receiving antenna if the external digital multimedia broadcasting receiving antenna is connected to the jack; and a switching module which inputs a broadcasting signal received through the antenna connection module to a satellite digital multimedia broadcasting module if the broadcasting signal is a satellite digital multimedia broadcasting signal and inputs the broadcasting signal to a terrestrial digital multimedia broadcasting module if the broadcasting signal is a terrestrial digital multimedia broadcasting signal.

According to another aspect of the present invention, there is provided a digital multimedia broadcasting receiver for receiving satellite digital multimedia broadcasting and terrestrial digital multimedia broadcasting, the digital multimedia broadcasting receiver including a radio frequency switching module which includes a terrestrial digital multimedia broadcasting antenna and a satellite digital multimedia broadcasting antenna; an antenna connection moduel which includes a jack used for connecting an external digital multimedia broadcasting receiving antenna and cuts off a signal receiving path of the RF switching module and receives a broadcasting signal from the external digital multimedia broadcasting receiving antenna if the external digital multimedia broadcasting receiving antenna is connected to the jack; and a switching module which inputs a broadcasting signal received throught the antenna connection module to a satellite digital multimedia broadcasting module if the broadcasting signal is a satellite digital multimedia broadcasting signal and inputs the broadcasting signal to a terrestrial digital multimedia broadcasting module if the broadcasting signal is a terrestrial digital multimedia broadcasting signal.

According to still another aspect of the present invention, there is provided a digital multimedia broadcasting receiver for receiving satellite digital multimedia broadcasting and terrestrial digital multimedia broadcasting, the digital multimedia broadcasting receiver including an antenna connection module which is connected with an internal digital multimedia broadcasting receiving antenna, includes a jack used for connecting an external digital multimedia broadcasting receiving antenna, and cuts off a signal receiving path of the internal digital multimedia broadcasting receiving antenna and receives a digital multimedia broadcasting signal from the external digital multimedia broadcasting receiving antenna if the external digital multimedia broadcasting receiving antenna is connected to the jack; and a switching module which inputs a broadcasting signal received through the antenna connection module to a satellite digital multimedia broadcasting module if the broadcasting signal is a satellite digital multimedia broadcasting signal and inputs the broadcasting signal to a terrestrial digital multmedia broadcasting module if the broadcasting signal is a terrestrial digital multimedia broadcasting signal.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of the conventional terrestrial digital multimedia broadcasting receiver;

FIG. 2 is a block diagram illustrating the structure of a public portable terminal having the conventional satellite digital multimedia broadcasting receiving function and the conventional portable phone function;

FIG. 3 is a block diagram illustrating the structure of a digital multimedia broadcasting receiver according to the first preferred embodiment of the present invention; and

FIG. 4 is a block diagram illustrating the structure of a digital multimedia broadcasting receiver according to the second preferred embodiment of the present invention.

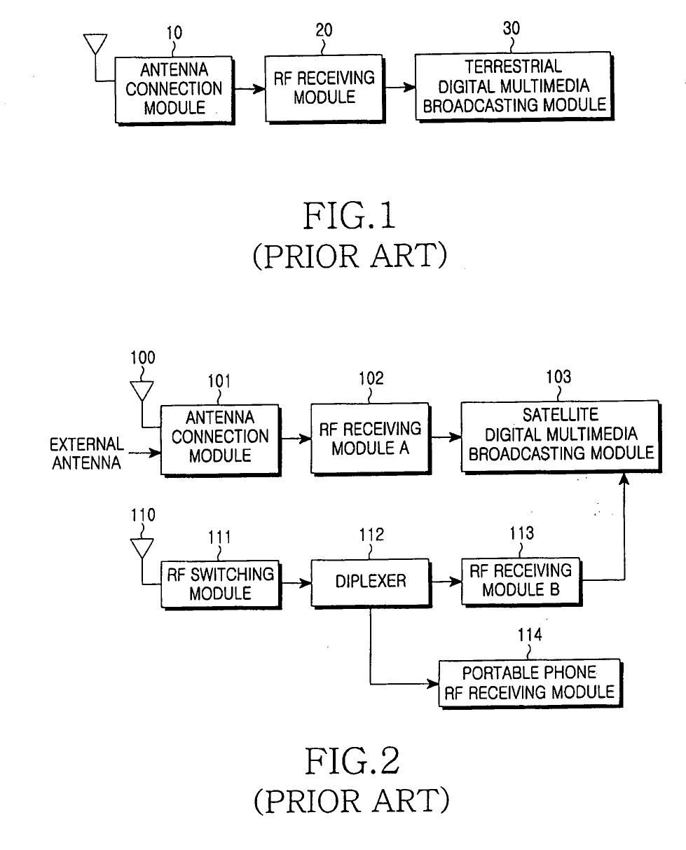

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

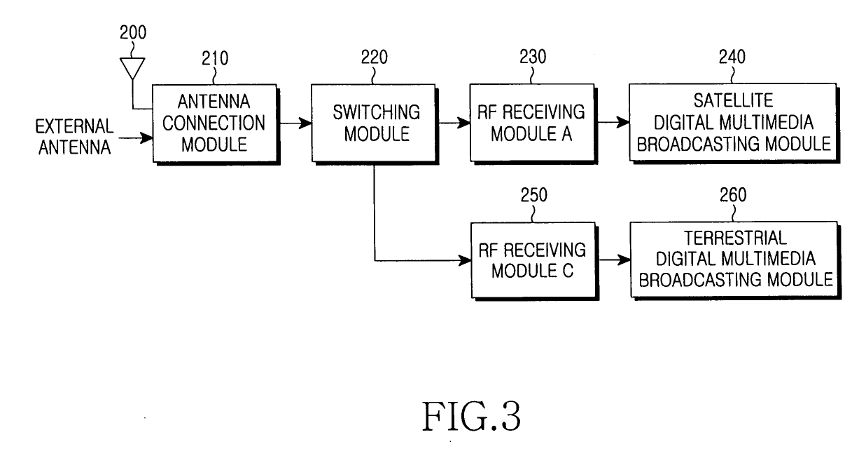

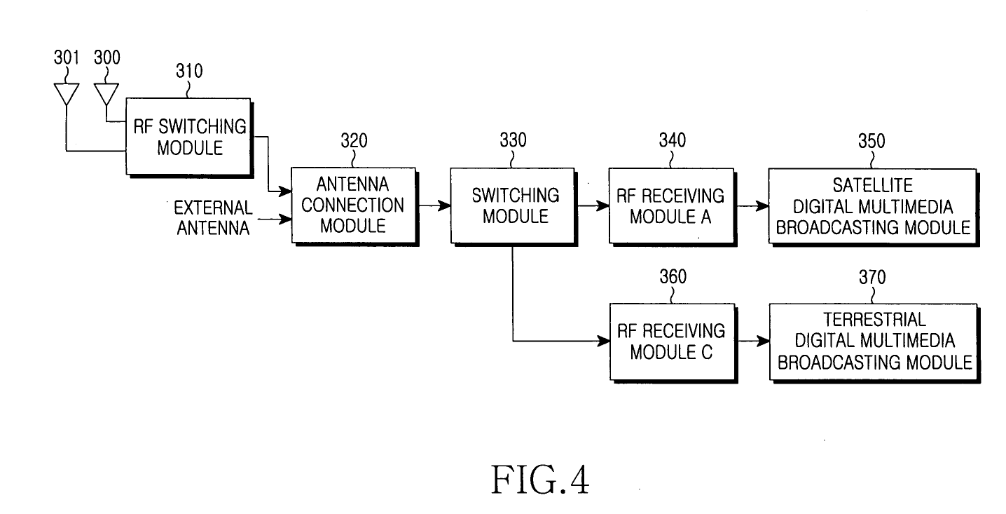

According to preferred embodiments of the present invention, a digital multimedia broadcasting receiver simultaneously providing satellite digital multimedia broadcasting and terrestrial digital multimedia broadcasting employs a diversity antenna for the satellite digital multimedia broadcasting. It is noted that only one diversity antenna for the satellite digital multimedia broadcasting is shown in FIGS. 3 and 4, and a remaining antenna not shown in FIGS. 3 and 4 has the same structure as the wide band antenna 110 shown in FIG. 2.

FIG. 3 is a block diagram illustrating the structure of a digital multimedia broadcasting receiver according to the present invention.

As shown in FIG. 3 a diversity antenna 200 for satellite digital multimedia broadcasting is connectd with an antenna connection moduel 210. The antenna connection module 210 includes a jack for connecting an external antenna in addition to the diversity antenna 200. The external antenna, which can be connected to the jack, includes an external satellite digital multimedia broadcasting antenna, an external terrestrial digital multimedia broadcasting antenna, or a vehicle terrestrial digital multimedia broadcasting antenna. The digital multimedia broadcasting receiver shown in FIG. 3 has a structure for employing the external antenna in order to receive a terrestrial digital multimedia broadcasting signal.

If the external antenna is connected to the antenna connection module 210 through a jack, the antenna connection module 210 cuts off a signal receiving path of the diversity antenna 200 and imputs a digital multimedia broadcasting signal received through the connected external antenna to a switching module 220. In addition, the antenna connection module 210 is used for connecting an RF test cable through the above-described jack.

If an input signal is a satellite digital multimedia broadcasting signal, the switching module 220 outputs the input signal to a satellite digital multimedia broadcasting module 240 through an RF receiving module A 230. If the input signal is a terrestrial digital multimedia broadcasting signal, the switching module 220 outputs the input signal to a terrestrial digital multimedia broadcasting module 260 through an RF receiving module C 250. The switching module 220 may be realized as a diplexer for determining a signal form according to the frequency of the received signal. In addition, as a user sets the digital multimedia broadcasting receiver for satellite digital multimedia broadcasting or terrestrial digital multimedia broadcasting, the switching module 220 inputs a broadcasting signal received through the antenna connection module 210 into the RF receiving module A 230 or the RF receiving module C 250 through the antenna connection module.

For example, if the digital multimedia broadcasting receiver is set as the satellite digital multimedia broadcasting receiver, the switching module 220 inputs a signal input through the antenna connection module 210 to the satellite digital multimedia broadcasting module 240 through the RF receiving module A 230. If the digital multimedia broadcasting receiver is set as the terrestrial digital multimedia broadcasting receiver, the switching module 220 inputs a signal input through the antenna connection module 210 to the terrestrial digital multimedia broadcasting moduel 260 through the RF receiving module C 250.

FIG. 4 is a block diagram illustrating the structure of a digital multimedia broadcasting receiver according to the present invention.

As shown in FIG. 4, a diversity antenna 300 for a satellite digital multimedia broadcasting and an internal antenna 301 for a terrestrial digital multimedia broadcasting are connected to an RF switching module 310. The RF switching module 310 inputs a satellite or terrestrial digital multimedia broadcasting signal recieved through the diversity antenna 300 or the internal antenna 301 to the antenna connection module 320 as a user sets the digital multimedia broadcasting receiver for satellite digital multimedia broadcasting or terrestrial digital multimedia broadcasting.

For example, if the digital multimedia broadcasting receiver is set as a STOPPED (First In First Out) memory. The queued segment information, that is the starting address and size, is written by the later mentioned service application process 331, and is read by the later mentioned transmission process 332.

The CPU 201 of the active server 101 constructs the user program 330, data duplication controller 340 and system manager 350 as software.

The user program 330 of the present embodiment is an object oriented program. The user program 330 includes a service application process 331, transmission process 332 and data synchronization client library 333.

The service application process 331 is an application to perform services for the user. When the active server 101 is performing a plurality of types of services, the CPU 201 executes a plurality of types of service application processes 331. The service application process 331 uses the synchronization memory area 311 of the shared memory area 310 as the memory area to perform the temporary storage of data and construction of instances.

The transmission process 332 reads information from the synchronization request queue 313, and reads the data corresponding to this information from the synchronization memory area 311. The transmission process 332 sends the information read from the synchronization request queue 313 and the synchronization memory area 311 to the data duplication client library 333.

The data duplication client library 333 receives information from the transmission process 332, and creates a synchronization data management table (not illustrated) using this information. For this, the data duplication client library 333 has an API (Application Program Interface) function to communicate with the user program 330. The synchronization data management table includes synchronization data, synchronization ID, starting address of synchronization data, size of synchronization data, user receive function and data and size of the unit. The synchronization data is data and instances to be synchronized. The synchronization ID is an ID assigned to the segment of the synchronization memory area 311, and is used to identify the synchronization data. The user receive function is a function in the user program 360 which is called when the data duplication client library 361 (described later) transfers data to the user program 360. The data and size of the unit is the data and size of the corresponding segment. The data duplication client library 333 receives transmission control information and transmission instructions from the data duplication controller, and sends the information stored in the synchronization data management table to the data duplication client library 361 (described later) of the standby server 102. This information is sent by the transmission thread 333a of the data duplication client library 333. This information is stored in the TCP (Transmission Control Protocol) queue 333b, and then sent from the TCP queue 333b in the stored sequence. As mentioned later, the creation and transmission of a table are executed asynchronously.

The data duplication controller 340 stores information necessary for control communication for synchronization, such as the port numbers of the data duplication client libraries 331 and 341. The data duplication controller 340 receives the synchronization start instruction or interruption instruction from the system manager 350, and sends this instruction and managed information to the data duplication client library 333.

The system manager 350 controls the start, interruption and stop of synchronization. The start timing of synchronization can be decided by the system manager 350 monitoring the status of the service application process 331, for example. The synchronization is interrupted when the active/standby of the servers 101 and 102 are switched by a failure occurrence or for other reasons of the service application process 331, for example. Also when the server 101 cannot be recovered from a failure for a long period of time, or when the server 101 is in a maintenance process, synchronization is stopped.

The CPU 201 of the standby server 102 constructs the user program 360, data duplication controller 370 and system manager 380 as software.

The user program 340 of the present embodiment is constituted by an object oriented program. The user program 340 includes the data duplication client library 341. The data duplication client library 341 creates the synchronization data management table using the information received from the data duplication client library 333. The data duplication client library 341 synchronizes the data stored in the synchronization memory area 321 with the data stored in the synchronization memory area 311 using the synchronization data management table.

The data duplication controller 370 and system manager 380 have the same configuration as the above mentioned data duplication controller 340 and system manager 350, but are not used when the server 102 is in standby status.

Now the operation of the redundancy server system 100 according to the present embodiment will be described.

First the operation of the server system 100 when the service application process 331 is normal will be described with reference to FIG. 4 and FIG. 5.

When the system is started, the user programs 330, 360 and other software start operation. As mentioned above, the user program 330 can operate a plurality of types of service application processes 331 in parallel.

Then the synchronization memory area 311, management bit map table 312 and synchronization request queue 313 are set in the shared memory area 310 of the active server 101 (see FIG. 4). The synchronization memory area 311 and management bit map table 312 are created for each service application process 331. In the shared memory area 320 of the standby server 102, the synchronization memory area 321 is set.

The user program 330 executes the service application process 331. When the service application process 331 starts up, one or more segments (segment #0 to #n in the example in FIG. 4) in the synchronization memory area 311 are allocated to this process 331. The service application process 331 performs the construction of instances and temporary storage of the data using these segments. Also the service application process 331 overwrites the data and instances in the synchronization memory area 311 if necessary. When a segment is written or overwritten, the service application process 331 sets a flag corresponding to this segment in the management bit map area 312 (see step S1 in FIG. 4). At the same time, the service application process 331 stores the information including the starting address and size of the segment to the synchronization request queue 313 (see step S2 in FIG. 4).

The transmission process 332 checks each flag of the management bit map area 312 (see step S3 in FIG. 5). The check timing is arbitrary. For example, the flag can be checked at each predetermined time. The flag may be checked when the total of sizes of the segments which require synchronization exceeded a predetermined value. In the case of checking at each predetermined time, check timing can be decided by the transmission process 332, for example. The total of the size of the segments which require synchronization can be computed by the service application process 331, for example. In this case, when the computation result exceeds the predetermined value, the service application process 331 instructs the transmission process 332 to check the flag.

If a flag being set exists, the transmission process 332 reads the queued information, that is the starting address and size of the segment, from the synchronization request queue 313 (see step S4 in FIG. 5). Then the transmission process 332 reads the stored information, that is synchronization data, from the segment corresponding to the information. The transmission process 332 also sends the information read from the segment and synchronization request queue 313 to the data duplication client library 333. The transmission process 332 then resets the flag corresponding to the synchronization data which was read. This series of processing is repeated until the flag being set no longer exists.

The data duplication client library 333 creates the synchronization data management table using information received from the transmission process 332. As mentioned above, the synchronization data management table includes the synchronization data, synchronization ID, starting address of the synchronization data, size of the synchronization data, user receive function and data and size of the unit.

The system manager 350 instructs the data duplication controller 340 to start synchronization at a predetermined timing. As mentioned above, the timing to start synchronization is decided by the system manager 350 according to the status of the service application process 331.

When the start instruction is received, the data duplication controller 340 sends this instruction and the above mentioned communication information to the data duplication client library 333.

When the instruction and information are received from the data duplication controller 340, the data duplication client library 333 generates packets which includes the information stored in the synchronization data management table, and queues the packets in the TCP queue 333b (see step S5 in FIG. 5). Then the transmission thread 333a sequentially reads the packets from the TCP queue 333b and sends the packets to the data duplication client library 361 of the standby server 102.

The data duplication client library 361 receives information corresponding to the synchronization data management table. Based on the received information, the data duplication client library 361 creates the synchronization data management table in the library 361.

Then the data duplication client library 361 sends the user receive function included in the synchronization data management table to the user program 360. Using this function, the user program 360 executes the process for storing the synchronization data to the synchronization memory area 321. In this write process, the synchronization data is written to the synchronization memory area 321 based on such information as the synchronization ID, starting address of the synchronization data, size of the synchronization data and data and size of the unit. By this, the same synchronization data is stored in the same address of the synchronization memory areas 311 and 321. The synchronization data may be directly written by the data duplication client library 361. In this case, the user receive function is not used.

Now the operation of the server system 100 when a software failure occurs in the service application process 331 will be described with reference to FIG. 6.

A known cause of a software failure is a memory fault, for example. The memory fault is a type of exception which occurs when a program attempts to access a memory area other than the allocated segment.

As mentioned above, the redundancy server system 100 of the present embodiment has a management bit map area 312 and synchronization request queue 313, so the transmission process 332 can recognize the segment written or overwritten by the service application process 331. Therefore according to the present embodiment, the service application process 331 and transmission process 332 can be operated independently. Even if a failure occurs to the service application process 331, the transmission process 332 can access the shared memory area 310. Therefore even if a failure occurs to the service application process 331, the data application client library 333 can perform processing to create the synchronization data management table (see step S6 in FIG. 6) and processing to send the synchronization data management table to the standby server 102 (step S7 in FIG. 6).

In the present embodiment, the data duplication client library 333 and data duplication controller 340 are installed separately, but these may be integrated.

What is claimed is:

1. A redundancy system, comprising:
a plurality of devices of which the active status and standby status can be switched;
a synchronization data memory installed in each of said plurality of devices;
a management bit map table having a flag created for each segment of said synchronization data memory in an active device;
a management memory for storing synchronization information including a starting address of said segment;
a first processor for performing service using one or a plurality of said segments, and setting said flag corresponding to said segment and writing said synchronization information to said management memory each time said segment is written or overwritten; and
a second processor for checking each flag in said management bit map table at a predetermined timing, and reading synchronization data from said segment corresponding to said synchronization information stored in said management memory and resetting said flag if a flag being set exists.

2. The redundancy system according to claim 1, wherein said active device further comprises a third processor for receiving said synchronization information and said synchronization data from said second processor, and creating a synchronization data management table including said synchronization information and said synchronization data.

3. The redundancy system according to claim 2, wherein said third processor sends information included in said synchronization data management table to another device.

4. The redundancy system according to claim 3, wherein said active device further comprises a system manager for monitoring the operation of said first processor and deciding the transmission timing of said third processor based on the monitoring result.

5. The redundancy system according to claim 4, wherein said active device further comprises a data duplication controller for sending a transmission start instruction and communication control information, for sending information included in said synchronization data management table to another device, to said third processor when said instruction is received from said system manager.

6. The redundancy system according to claim 5, wherein said standby device further comprises a fourth processor for creating said synchronization data management table using information received from said third processor.

7. The redundancy system according to claim 6, further comprising a fifth processor for synchronizing stored data of said synchronization data memories in said active device and said standby device by overwriting the stored data of said synchronization data memory in said standby device using said synchronization data management table created by said fourth processor.

8. The redundancy system according to claim 6, wherein said fourth processor synchronizes the stored data of said synchronization data memories in said active device and said standby device by overwriting the stored data of said synchronization data memory in said standby device using said synchronization data management table created by said fourth processor.

9. The redundancy system according to claim 1, wherein the stored data of said synchronization data memory includes an instance constructed by an object oriented progr
